(19) United States
(12) Patent Application Publication
(10) Pub. No.: US 2008/0192281 A1
(43) Pub. Date: Aug. 14, 2008

(54) MULTI FUNCTION PERIPHERAL APPARATUS AND PRINTING METHOD FOR THE SAME

(75) Inventor: Takahiro Hagiwara, Chiba-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/673,993

(22) Filed: Feb. 12, 2007

(51) Int. Cl. B41B 1/02

(52) U.S. Cl. 358/1.15

(57) ABSTRACT

In an MFP apparatus of the invention, a printing order registration unit registers, with respect to a plurality of print jobs including a plurality of image data, a printing order of each of the plurality of image data for each of the print jobs, a priority setting unit sets a priority to each of the plurality of print jobs, and an image data assigning unit assigns each of the plurality of image data to either one of the print processing units based on the printing order and the priority, and by this, a print waiting time can be shortened.

### BACKGROUND OF THE INVENTION

1. Field of the Invention

The present invention relates to an MFP (Multi Function Peripheral) apparatus which has a plurality of functions, such as, for example, print, FAX and copy, and processes a plurality of print jobs capable of being parallel-processed at the same time, and a printing method used for the MFP apparatus.

2. Description of the Related Art

Hitherto, as a technique to process a plurality of print jobs, there is proposed an image processing apparatus including a plurality of drawing modules capable of performing parallel processing and determination means for distributing print jobs to optimum drawing modules and for selecting a printer preferentially set for the distributed drawing modules from among a plurality of printers (for example, JP-A-2002-215352). Besides, there is also proposed a printer apparatus in which one or a plurality of print jobs are assigned to trays in empty state among a plurality of trays in turn, an image is generated based on the assigned print job, and when the generated image is printed, paper discharge to the plurality of trays is switched every predetermined Time and papers are discharged (for example, JP-A-2003-39779) However, in the processing of the plurality of print jobs using the technique of the related art, when another succeeding print job, such as urgent color printing, is performed while the printing apparatus is processing a print job requiring much time until completion, such as color printing of a large amount of paper, the succeeding print job is waited In the case where the plurality of print jobs are processed by separate drawing modules, although the plurality of print jobs are parallel-processed, in the case where the plurality of print jobs are processed by the same drawing module, the succeeding print job is waited, and the print waiting time can not be shortened.

Besides, in the case where the print processing is performed using the plurality of paper discharge trays, since the order of printing is fixed according to the paper discharge trays, the plurality of print jobs sent in the sane order are equally assigned and are processed. Accordingly, setting of the order of printing can nor be changed.

### DESCRIPTION OF THE DRAWINGS

FIG. 1 is a block diagram of an MFP apparatus according to an embodiment of the invention.

FIG. 2A is a view for explaining the sorting of papers in the MFP apparatus according to the embodiment of the invention.

FIG. 2B is a view for explaining the other sorting of papers in the MFP apparatus according to the embodiment of the invention.

FIG. 3 is a view for explaining a situation in which one job is parallel-processed by a plurality of print output units.

FIG. 4 is a view showing an example of the order of image data processed in FIG. 3.

FIG. 5 is a view for explaining a processing situation in a print processing unit when two jobs occur simultaneously.

FIG. 6 is a view showing an example of the order of image data processed in FIG. 5.

FIG. 7 is a view for explaining a processing method of a plurality of jobs to which priorities are given.

FIG. 8 is a view for explaining a situation after the plurality of jobs are processed using the priorities.

FIG. 9 is a view showing an example of the order of image data processed in FIG. 7.

FIG. 10 is a view for explaining a situation in which printing becomes unable to be continued in a print processing unit.

FIG. 11 is a view for explaining a processing of removing a paper in a non-operating print processing unit.

FIG. 12 is a view showing an example of the order of image data processed in FIG. 11.

FIG. 13 is a view for explaining a change assigning processing of a plurality of jobs.

### DETAILED DESCRIPTION OF THE INVENTION

Throughout this description, the embodiments and examples shown should be considered as exemplary, rather than limitations on the apparatus and methods of the present invention.

Hereinafter, embodiments of the invention will be described in detail taking the accompanying drawings as examples.

Incidentally, in the respective drawings, the same portions are denoted by the same reference numerals and their duplicate description will be omitted.

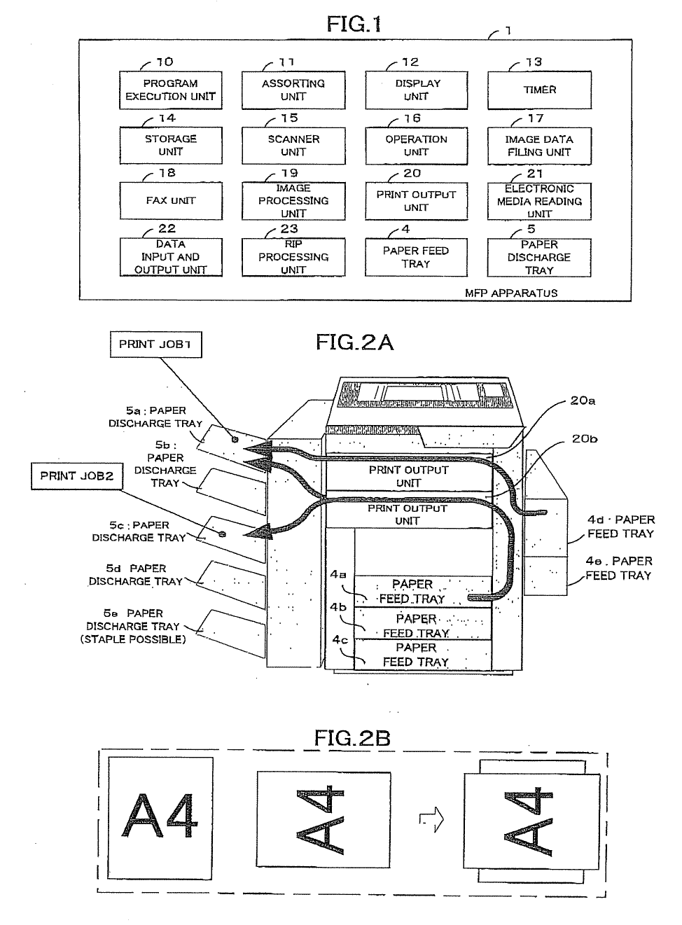

An MFP apparatus 1 according to an embodiment has various functions such as a print function, a FAX transmission and reception function and a copy function, and is an apparatus being capable of operating while the respective functions are merged. As shown in FIG. 1, the MFP apparatus 1 includes a program execution unit 10, an assorting unit (sorting unit) 11, a display unit 12, a timer 13, a storage unit 14, a scanner unit 15, an operation unit 16, an image data filing unit 17, a FAX unit (FAX transmission and reception processing unit) 18, an image processing unit 19, a plurality of print output units 20, an electronic media reading unit 21, a data input and output unit 22, a plurality of RIP (Raster Image Processor) processing units 23, a plurality of paper feed trays 4, and a plurality of paper discharge trays 5.

Incidentally, PIG. 1 shows one of the plurality of print output units 20, one of the plurality of RIP processing units 23, one of the plurality of paper feed trays 4 and one of the plurality of paper discharge trays 5. The MFP apparatus 1 is connected to a LAN through the data input and output unit 22, and can transfer data to and from an external apparatus, such as a PC (personal computer), connected to the LAN. The MFP apparatus 1 is connected also to a public line through the FAX unit 18.

The scanner unit 15 optically reads an original document and generates image data. The FAX unit 18 decodes encoded data sent from the public line or the like and generates image data. Each of the plurality of RIP processing units 23 interprets (analyzes) or renders PDL data or FDL file data generated in PDL (Page Description Language) format and sent from the network, and generates image data from the PDL data. The electronic media reading unit 21 reads image data from a CD-ROM or a memory card such as a compact flash.

The image processing unit 19 converts the image data read by the electronic media reading unit 21 into printable image data, or adjust the color, brightness or fineness of the read image data, or distinguishes an image from the read image data, and converts the image data according to the distinguished result so that a better print output can be obtained.

The image data filing unit 17 is for storing the image data of a scanner image, a FAX image or a print image. The management and edit of the stored image data is performed by the image data filing unit 17, and the edited image data is reprinted.

Each of the plurality of print output units 20 is a print processing unit to print-process a plurality of data with printing order in turn. The print output unit 20 prints the image data obtained by the scanner unit 15, the image data filing unit 17, the FAX unit 18 or the electronic media reading unit 21, or the image data processed by the image processing unit 19 or the RIP processing unit 23 onto paper The print output unit 20 includes an image formation unit to print an image formed with toner or ink onto paper, and a transport mechanism to transport paper from the paper feed tray 4 to the paper discharge tray 5 along a paper passing path Detection means, such as a not-shown sensor, for detecting an operating state of either one print output unit 20 of the plurality of print output units 20 is attached to the MFP apparatus 1. The operating state representing that the print output unit 20 is operating or not operating is detected by this sensor.

The program execution unit 10 includes a storage device as an image data storage unit to store the image data, performs such a processing as to control the printing order of the image data onto paper, and controls or manages the printing order for each of the image data. The program execution unit 10 executes a program to suitably control each of the scanner unit 15, the image data filing unit 17, the FAX unit 18, the image processing unit 19, the print output unit 20, the electronic media reading unit 21, the data input and output unit 22, and the RIP processing unit 23. The program execution unit 10 includes also a temporal storage area for processing data or file. The processing of the program execution unit 10 cooperates with each of the storage unit 14, the data input and output unit 22, the operation unit 16, the display unit 12, the assorting unit 11, and the timer 13 to determine the timing of management and print operation of a plurality of jobs.

The storage unit 14 stores data in a period necessary for processing, and the data input and output unit 22 exchanges data with an external apparatus, and temporally spools the print data The storage unit 14 and the data input and output unit 22 are constructed of storage devices. The operation unit 16 is used by a user to operate an equipment such as the MFP apparatus 1, for example, to change the setting of priority described later, and the display unit 12 displays information necessary for the operation. The operation unit 16 and the display unit 12 are constructed of, for example, a touch panel and a drive circuit of the touch panel. By this, the number of sheets of paper printed per one minute is set for each of the plurality of print output units 20.

The assorting unit 11 is a sorting unit to sort (divide or distribute) papers printed in the plurality of print output units 20 to a tray of the plurality of trays. The plurality of trays are attached to paper discharge ports as paper discharge destinations in a detachable state. The assorting unit 11 suitably sorts the papers from the respective print output units 20 into desired trays. In the paper sorting process by the assorting unit 11, the papers can also be sorted by alternately changing the paper direction longitudinally or laterally.

The respective functions of the RIP processing unit 23, the image processing unit 19, the image data filing unit 17 and the program execution unit 10 and the control functions of the print jobs in the scanner unit 15, the FAX unit 18, the electronic media reading unit 21 and the print output unit 20 are realized by a CPU (Central Processing Unit), ROM and RAM, IC or LSI. The function of the detection means is realized by the CPU, ROM, RAM, IC, LSI or the timer 13.

The MFP apparatus 1 of the embodiment prints the image data inputted from various input devices, such as the image data from the FAX or the network, or the optically read image data, onto paper fed to the paper feed tray 4, and discharges the printed paper to the paper discharge tray 5. For example, like network printing and printing of FAX received original documents, in the case where a plurality of print jobs overlap with each other, the MFP apparatus 1 suitably controls the order of print output. In the case where a succeeding copy job, a FAX job or another print job exists in the middle of the process of a job requiring much time for printing, the MNPE apparatus 1 uses a part of the plurality of print output units 20 to perform printing, and divides and arranges the plurality of printed papers for each job by the downstream side assorting unit 11. By this, the convenience of the user, and the operating rate of the apparatus are improved.

As an example, in the case where the MPP apparatus 1 prints 600 original documents by using the two print output units 20 each having a copying speed of 30 sheets/minute, when the two print output units 20 alternately print, and the job is processed at a rate of 60 sheets/minute, a job subsequent to this job is waited for about 10 minutes. In the MFP apparatus 1 of this embodiment, the print job whose processing has been started previously, and the print job subsequent to this print job can be adjusted according to the priority, and the order of sending image data to the plurality of print output units 20 can be re-scheduled. The print original documents printed in the respective print output units 20 are sorted for each job in the downstream side assorting unit 11 and are discharged. That is, the MFP apparatus 1 can set the print ratio according to the number of pages to be outputted per unit rime.

By this, the MFP apparatus 1 can dynamically change the ratio of the number of pages to be printed according to the priority whose setting can be changed by the user, and can complete the printing within a suitable print waiting time according to the already set priority. In the case where a succeeding print job is interruption-printed, the MFP apparatus 1 uses a plurality of print engines having equal functions to perform parallel processing, and perform print control with a high degree of freedom according to the state of trays for paper discharge.

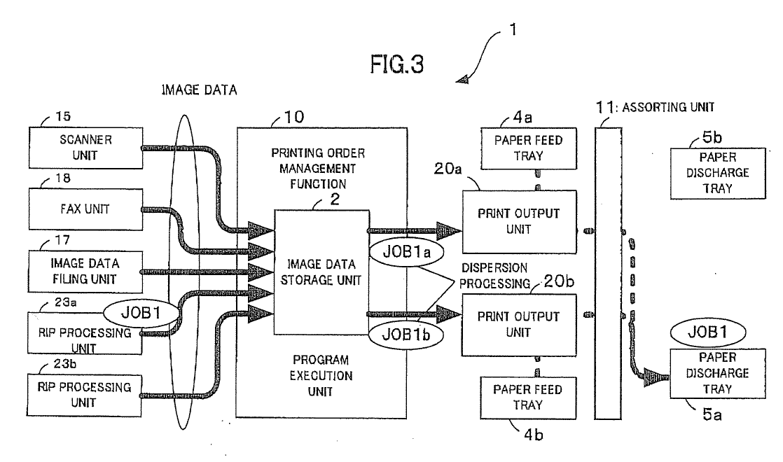

As shown in FIG. 2A, the MFP apparatus 1 of the embodiment uses a finishing apparatus to sort papers. The MFP apparatus 1 includes print output units 20a and 20b equal to the print output unit 20, paper feed trays 4a to 4e equivalent to the paper feed tray 4, and paper discharge trays 5a to 5e equivalent to the paper discharge tray 5. The MFP apparatus 1 prints one print image on one or a plurality of papers according to the content of the print job, and prints a plurality of print images on one or a plurality of papers. Specifically, in the case where the MFP apparatus 1 generates one print image by the occurrence of a copy operation, FAX reception, print instruction through the network, or a print operation of inner data of the MFP apparatus 1, the MFP apparatus 1 prints the one print image on a plurality of papers. Besides, in the case where the MFP apparatus 1 generates a plurality of print images by the occurrence of the copy, FAX, network printing, or printing of inner data, the MFP apparatus 1 prints each of the plurality of print images on one or a plurality of papers.

In the case where one or a plurality of print images are printed on a plurality of papers in the MEF apparatus 1, when one print image is generated, the generated print image is printed on the plurality of papers by either one of or both of the print output unit 20a and the print output unit 20b. The printed plurality of papers are sorted into the paper discharge trays 5a to 5e for each job and are discharged.

Besides, the two print output units 20a and 20b can be controlled so as to operate simultaneously. By the simultaneous operation control, a plurality of papers fed from either one of the plurality of paper feed trays 4a to 4e are printed with toner or ink in the two print output units 20a and 20b, and the plurality of printed papers are discharged to either one of the plurality of paper discharge trays 5a to 5e.

Incidentally, in FIG. 2A, although the paper feed source trays and the paper discharge destination trays are provided at five places, the number of trays may be decreased or increased according to the degree of congestion of the plurality of print jobs. Besides, in FIG. 2A, although the two print output units 20a and 20b are provided, the number of print output units 20 may be decreased or increased according to the degree of congestion of the plurality of print jobs and the size of a housing of the MFP apparatus 1.

The above description relates to the case where papers are sorted mechanically. As shown in FIG. 2B, the MFP apparatus 1 of the embodiment can perform a control to sort papers such that the assorting unit 11 discharge the paper while alternately changing the direction of the paper longitudinally or laterally. Although the sorting using the direction of the paper of FIG. 2B is for the case where papers are discharged to the same tray, the MFP apparatus 1 can sort papers by using both the sorting using the direction of the paper and the mechanical sorting of FIG. 2A. By this, variations for sorting can be increased.

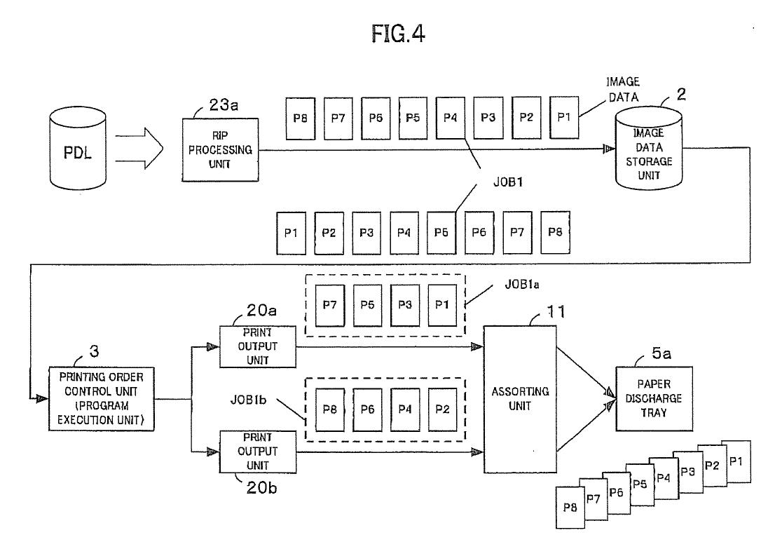

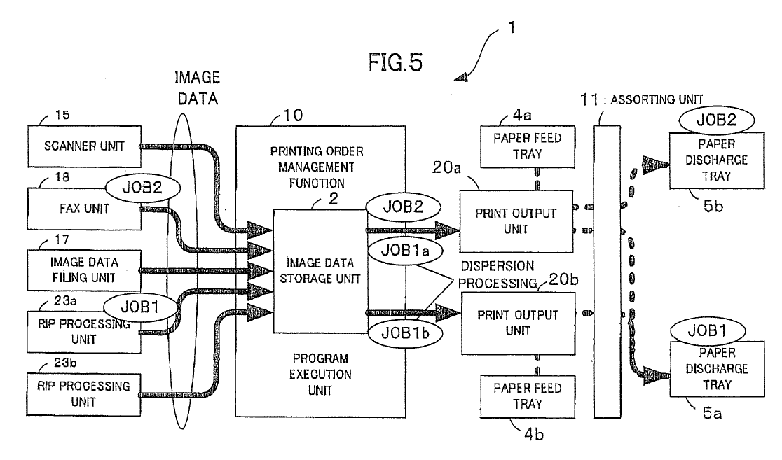

Next, a case where one print job is parallel-processed in two print output units 20a and 20b will be described. Specifically, a description will be given to an example of a case where a print operation of application data (file or data generated by application software of a word processor or the like) is performed in a PC or the like. The relation between the image data to be printed and the flow of transported paper is as shown in FIG. 3 and FIG. 4. Here, it is assumed that the same kind of papers are placed in the paper feed trays 4a and 4b, and units with the same functions are contained in the print output units 20a and 20b.

With respect to a plurality of print jobs including, for example, eight image data, the program execution unit 10 functions also as a printing order registration unit to register a printing order of each of the eight image data for each print job, a priority setting unit to set a priority to each of the plurality of print jobs, and an image data assigning unit to assign each of the eight image data included in the plurality of print jobs to a print output unit of the two print output units 20a and 20b based on the printing order registered in the printing order registration unit and the priority set in the priority setting unit. The printing order control unit 3 shown in FIG. 4 corresponds to the function as the image data assigning unit among the plurality of functions of the program execution unit 10.

In the program execution unit 10, the time when the eight image data are generated as printable image data in the print output units 20a and 20b, the time when the generated printable image data are stored in the image data storage unit 2, or the time when the generated printable image data are registered in a not-shown printing order registration unit is made the registration time, this registration time is managed as the printing order.

In the case where the number of print jobs is one, in FIG. 4, the print data from the PC is sent as the data in the PDL format to the MFP apparatus 1. The PDL data is converted into the printable image data by the RIP processing unit 23a, and for example, image data (or image data pieces) P1 to P8 of from page 1 to page 8 are generated. The generated image data P1 to P8 are stored in the image data storage unit 2, and at the same time as this storage processing, the image data P1 to P8 are read by the printing order control unit 3 as the image data assigning unit. Among the read image data P1 to P8, the image data P1, P3, P5 and P7 corresponding to the odd pages are sent to the print output unit 20a by the printing order control unit 3, and the image data P2, P4, P6 and P8 corresponding to the even pages are sent to the print output unit 20b. In the print output units 20a and 20b, in accordance with the sent image data, images with toner or ink are printed on papers for the respective pages, and the plurality of printed papers are sent to the assorting unit 11. The plurality of printed papers are collected by assorting unit 11 to the paper discharge tray 5a and are discharged.

As stated above, since the print output units 20a and 20b have the same function, the job 1 is equally distributed into the job 1a and the job 1b and is parallel-processed. By this, the dynamic control becomes possible such that the odd pages are printed by the print output unit 20a, and the even pages are printed by the print output unit 20b. Incidentally, the printing order control unit 3 can also perform a control such that the odd pages and the even pages are printed in the print output unit 20b and the print output unit 20a, respectively, and can also perform a control so as to selectively print a desired page. As stated above, the MFP apparatus 1 has the function to manage the printing order.

In the printing method of the embodiment, with respect to a plurality of print jobs, such as three print jobs 1 to 3, the program execution unit 10 registers the printing order of each of a plurality of image data for each print job, sets a priority to each of the print jobs, assigns each of the plurality of image data included in these print jobs to either one of the print output units 20a and 20b based on the printing order and the priority, and causes the assigned print output unit to print each of the plurality of image data included in the plurality of print jobs.

In the case where separate drawing modules are selected for the plurality of print jobs, the MFP apparatus 1 executes a parallel processing. In the case where the same drawing module is selected for the plurality of print jobs, the MFP apparatus 1 prints, without a waiting time of print processing, a print job subsequent to a print job whose processing has been started. By this, the print waiting time is shortened.

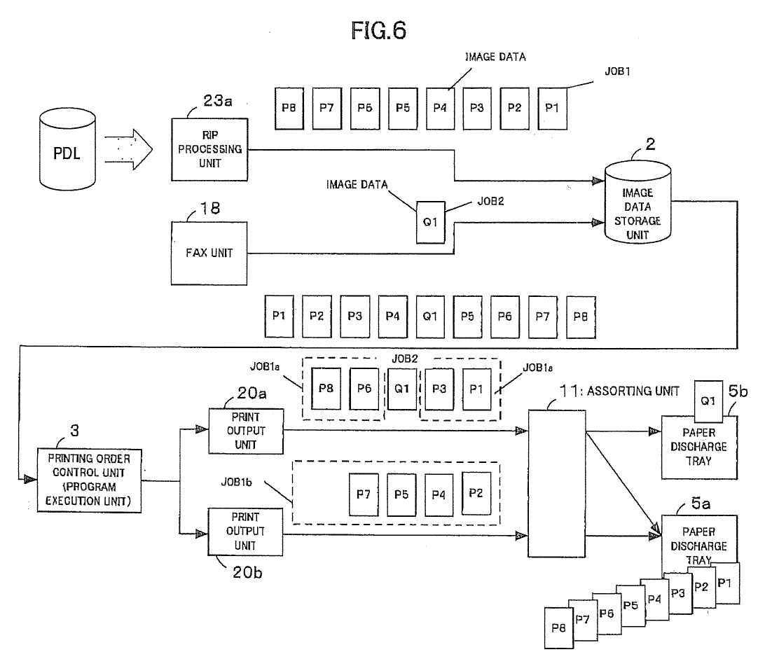

Next, in the case where two jobs, that is, a job 1 in the RIP processing unit 23a and a job 2 in the FAX unit 18 occur at the same time, the relation between image data to be printed and the flow of transported paper will be described with reference to FIG. 5 and FIG. 6. Here, for simplification of the description, it is assumed that the jobs to be simultaneously processed have the same priority.

Similarly to the case where one print job is parallel-processed in the print output units 20a and 20b, image data of eight pages from the RIP processing unit 23a and image data of one page from the FAX unit 18 are sent to the image data storage unit 2 and are stored, and these image data, together with the registration times when the image data themselves are registered, are managed. Here, it is assumed that image data Q1 of the job 2 is registered between image data P4 and P5 of the job 1.

The printing order control unit 3 reads the plurality of image data stored in the image data storage unit 2 in the order of the registration time, and sends the read image data to the print output units 20a and 20b. The respective image data are printed on papers in the print output units 20a and 20b, the plurality of printed papers are sent to the assorting unit 11, and the assorting unit 11 collects the plurality of sent papers for each job and discharges them to the suitable paper discharge trays 5a and 5b. Incidentally, in FIG. 6, the job 1 is discharged to the paper discharge tray 5a, and the job 2 is discharged to the paper discharge tray 5b.

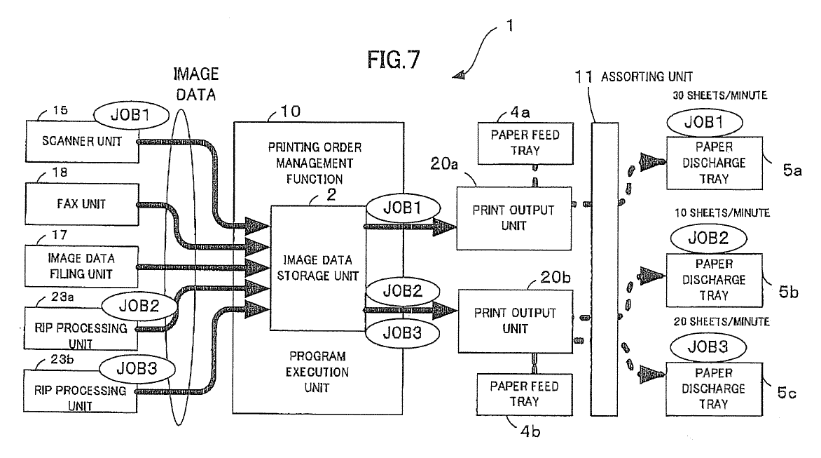

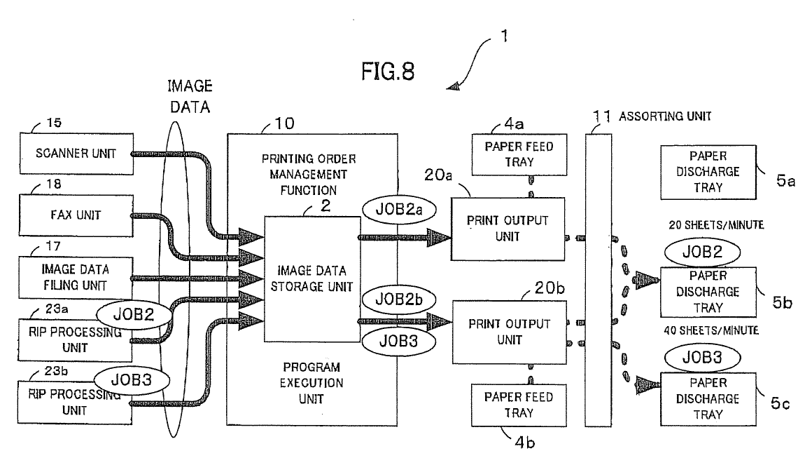

Next, a case where a different priority is given to each job will be described. For example, an example of a case where three jobs simultaneously occur will be described. A job 1 shown in FIG. 7 occurs by a copy process, and by this, scan image data of an original document by a copy operation is sequentially stored in the image data storage unit 2 from the scanner unit 15. At the same time as this storage, a print job 2 of application data in the PC or the like is sent as PDL data. This PDL data is converted into print image data by the RIP processing unit 23a, and the print image data is stored in the image data storage unit 2. As shown in FIG. 7, in the MFP apparatus 1 of this embodiment, since a plurality of, for example, two RIP processing units 23a and 23b are provided, the MFP apparatus 1 can process, as a job 3, the print job of the application data from the PC or the like simultaneously with the processing of the two jobs.

With respect to the printable image data of the jobs 1, 2 and 3 stored in the image data storage unit 2, the program execution unit 10 selects the paper feed tray trays 4a and 4b for printing of the image data, the print output units 20a and 20b, and the paper discharge trays 5a, 5b and 5c based on various parameters described below, and performs print control of the respective image data. The parameters indicate the registration time registered in the image data storage unit 2, the priority of the job, the state of the remaining amount of paper in the plurality of paper feed trays 4a to 4e, the print function of the plurality of print output units 20a and 20b, the use state of the input apparatus such as the scanner unit 15 or the FAX unit 18, the operating states of the plurality of print output units 20a and 20b, the paper passing paths from the plurality of paper feed trays 4a to 4e to the plurality of paper discharge trays 5a to 5e, and information indicating whether paper discharge to the plurality of paper discharge trays 5a to 5e can be performed. The registration time is acquired by the timer 13, the priority of the job is acquired by the operation unit 16, and the remaining amount of paper, the possibility of paper discharge and the like are acquired by the sensor.

In FIG. 7, in the case where the priorities of the jobs 1, 2 and 3 are set such that “as the numeral becomes small, the priority becomes high”, since the priority of the job 1 as the front end job such as copy is highest, the job 1 occupies the print output unit 20a (or the capacity of print processing of the print output unit 20a) The printing of the job 1 is performed at the maximum speed, and with respect to the jobs 2 and 3 as the background jobs, the print output unit 20b is used in time division, and papers about the jobs 2 and 3 are sorted to the paper discharge trays 5b and 5c and are outputted, As shown in FIG. 7, in the case where the respective priorities of the jobs 2 and 3 are different from each other, the ratio of the use times of the jobs 2 and 3 using the time division of the print output unit 20b is controlled according to the priorities. In FIG. 7, it is assumed that priority 2 is set to the job 2, priority 1 is set to the job 3, and the assigned capacity of the print processing per unit time with respect to the priority 1 is set to be twice as large as the assigned capacity of the print processing per unit time with respect to the priority 2. Further, when each of the print output units 20a and 20b can print 30 sheets of paper per one minute, the processing is performed at such a ratio that 10 sheets of paper are printed per one minute for the job 2, and 20 sheets of paper are printed per one minute for the job 3.

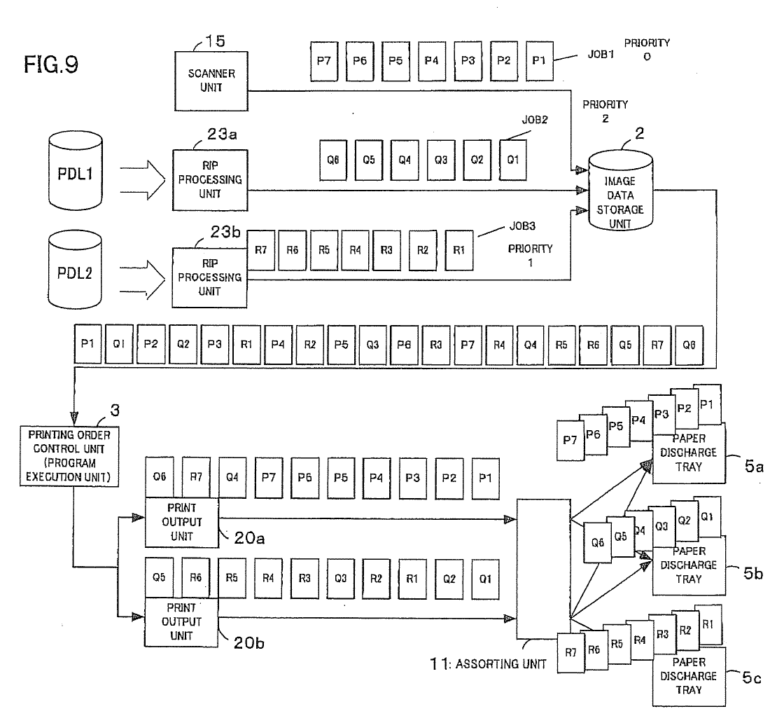

In FIG. 7, when the job 1 is completed earlier, and both the job 2 and the job 3 remain, the program execution unit 10 dynamically distributes the jobs 2 and 3 to the print output units 20a and 20b. As an example, the job 2 is divided, and a part of the divided job 2 is distributed to the print output unit 20a. With respect to the job 2 distributed to the print output unit 20a, 20 sheets of paper are printed per one minute. The job 3 is also divided in two. With respect to one of the divided job 3, 10 sheets of paper are printed per one minute by the print output unit 20a. With respect to the other of the divided job 3, 20 sheets of paper are printed per one minute by the print output unit 20b. As stated above, the plurality of jobs are dynamically controlled by the program execution unit 10, and as shown in FIG. 8, the print processing is performed at the optimum distribution.

The order of the image data of the print image of FIG. 7 and FIG. 8 will be described by use of FIG, 9. Image data P1 to P7 of the scan image are stored in the image data storage unit 2. Together with this storage processing, image data Q1 to Q6 and image data R1 to R7 generated in the RIP processing unit 23a and the RIP processing unit 23b are stored in the image data storage unit 2. In these storage processings, the printing order control unit 3 registers the times when the image data P1 to P7 are stored, and registers and sets priority 0 to the image data P1 to P7 as the print job 1. Similarly, the printing order control unit 3 registers the times when the image data Q1 to Q6 and R1 to R7 are stored, sets priority 2 to the image data Q1 to Q6 as the print job 2, and sets priority 1 to the image data R1 to R7 as the print job 3 The printing order control unit 3 reads all image data stored in the image data storage unit 2 in accordance with the stored times and the priorities 0, 1 and 2, and distributes all the image data to the print output units 20a and 20b.

In this case, the job 1 (P1 to P7) occupies the print output unit 20a, and the print processing on the job 1 is performed The first data Q1 and Q2 of the job 2 (Q1 to Q6) are continuously printed by the print output unit 20b. After the job 3 (R1 to R7) with the higher priority is started to be processed, the processing is distributed so that after the image data R1 and R2 of two pages are print-processed for the job 3, the image data Q3 of one page is print-processed for the job 2. In this way, the program execution unit 10 dynamically distributes the processing of the plurality of jobs, and by this, the suitable print processing is performed.

Next, with respect to an operation processing at the time when either one of the two print output units 20a and 20b becomes unable to operate by a jam or toner depletion, a description will be given to a recovery processing in which printing is automatically continued in the case where at least one of the print output units 20a and 20b is operable.

The program execution unit 10 selects one of the print output units 20a and 20b different from what is detected to be non-operating by the sensor, for example, the print processing unit 20b different from the print processing unit 20a, and assigns image data subsequent to image data, which is assigned at the time when the detection of being non-operating has been performed, of the plurality of image data included in the plurality of print jobs to the selected print processing unit 20b.

The program execution unit 10 selects the print processing unit 20b different from the print processing unit 20a detected to be non-operating by the sensor, and assigns image data to be printed in the print processing unit 20a among the plurality of image data included in the plurality of print jobs to the selected print processing unit 20b.

In the printing method of the embodiment, the MPP apparatus 1 detects the operating state of a print processing unit of the print processing units 20a and 20b, selects the print processing unit 20b, and again prints the image data to be printed in the print processing unit 20a among the plurality of image data by the selected print processing unit 20b. Besides, the MFP apparatus 1 detects that the printing order of the plurality of image data is different from the registered printing order, and changes the print processing unit 20a assigned to the image data detected to be different in the printing order among the plurality of image data to the print processing unit 20b.

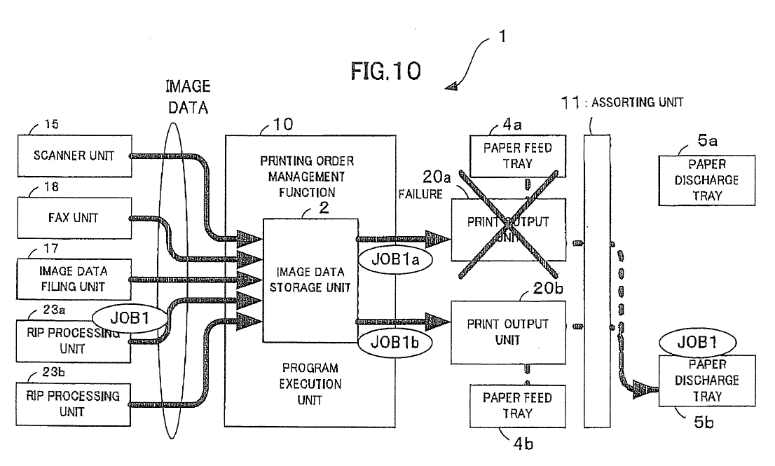

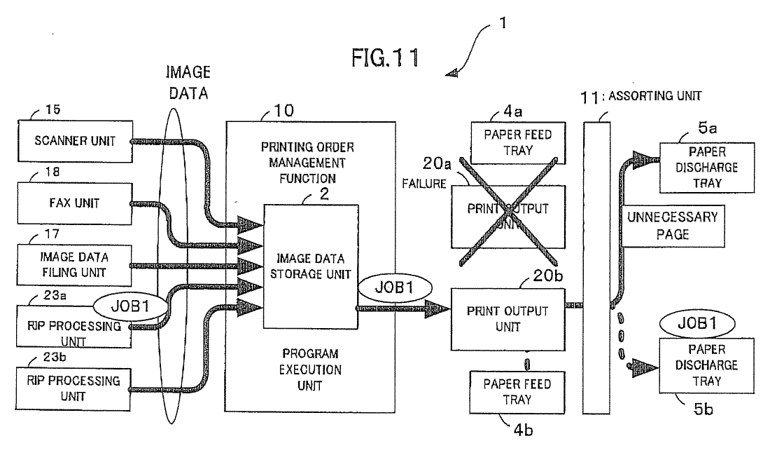

The change assignment of the print job will be described based on the example in which the plurality of jobs are processed described in FIG. 3 before. It is assumed that one print job 1 is parallel-processed as jobs 1a and 1b in the two print output units 20a and 20b, and there occurs a situation in which, for example, while image data P3 is being printed, as shown in FIG. 10, for example, in the print output unit 20a, a jam occurs in the middle of the printing of the image data P3, and the printing in the print output unit 20a can not be continued. In this case, since papers on which images of the two jobs 1a and 1b are printed are not transported in a common transport path, both printings can be continued. However, the scheduling by the printing order control unit 3 is such that odd pages are printed by the print output unit 20a, and even pages are printed by the print output unit 20b, and therefore, the image data P3 must be again printed by another print output unit. However, at this time, since the image data P4 is printed in the other print output unit 20b, when the printing is continued, the order of pages of the printed papers becomes incorrect.

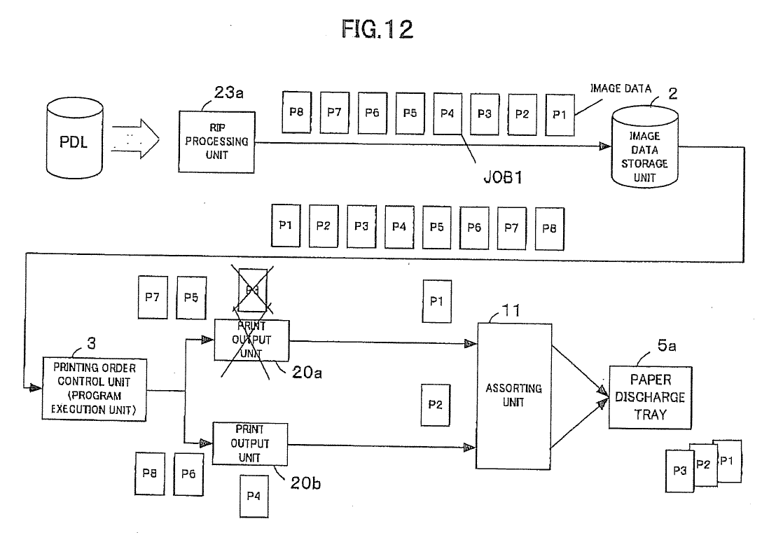

In the case where a situation in which the order of pages of papers can become incorrect by continuation of printing, for example, a failure is detected, as shown in FIG. 11, the MFP apparatus 1 of the embodiment removes the paper on which the image data P4 has been printed and which remains in the print output unit 20b. Thus, the program execution unit 10 automatically discharges the unnecessary paper on which the image data P4 has been printed to a paper discharge tray not used. After the paper discharge processing, the program execution unit 10 causes the operating print processing unit 20b to continue re-printing from the page on which the jam occurred The relation between the image data to be printed in this case and the flow of transported paper will be described in more detail with reference to FIG. 12. The printing order control unit 3 reads the print image data P1 to P8 stored in the image data storage unit 2 in accordance with the schedule created in view of the priority, and sends the image data P1 to P8 to the two print output units 20a and 20b. The sent print image data P1 to P8 are printed on the papers in the respective print output units 20a and 20b. The printed papers are sent to the assorting unit 11 and the respective papers are discharged to the suitable paper discharge trays by the assorting unit 11.

It is assumed that in the print output unit 20a given x in FIG. 12, a jam or the like occurs while the image data P3 is being printed on a paper, and there occurs a state in which printing can not be continued. In the case where the print output unit 20a is assigned to print odd pages, when the processing is continued as it is, pages subsequent to P3, such as pages (for example, P5, P7) to be printed by the print output unit 20a, are not printed. When detecting by a sensor or the like that the print output unit 20a can not be used, the program execution unit 10 first stops to send the print image data to the print output unit 20a.

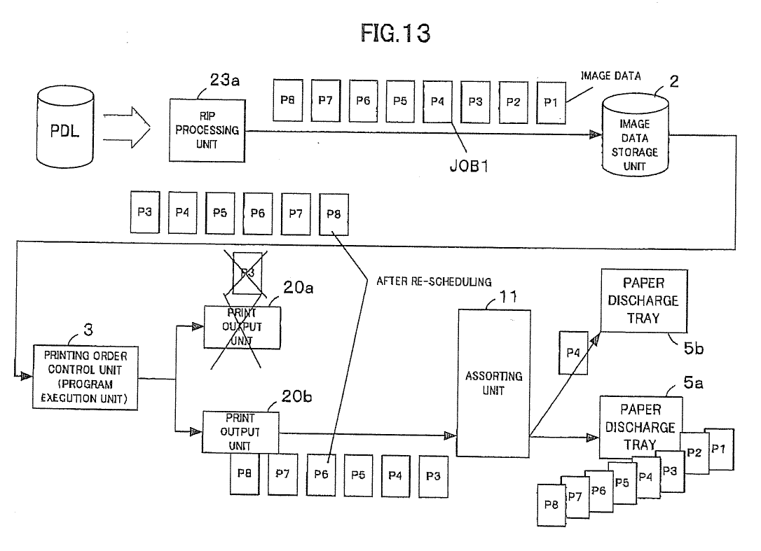

Next, as shown in FIG. 13, the MFP apparatus 1 of the embodiment discharges the paper on which the image data P4 has been printed and which exists in the print output unit 20b to the paper discharge tray 5b. At the same time as the paper discharge processing to the paper discharge tray 5b, the MFP apparatus 1 discards the schedule used before the occurrence of the jam, and further changes the scheduling so as to perform re-printing, in the print output unit 20b, of the image data P3 which has not been printed by the jam, re-printing, in the print output unit 20b, of the image data P4 about the paper discharged to the paper discharge tray 5b, and printing, in the print output unit 20b, of the remaining pages (P5 to P8). By this, subsequently to the pages corresponding to the image data P1 and P2 already discharged, the image data P3 to P8 are printed on papers by the print output unit 20b, and the image data P1 to P8 are correctly printed.

That is, the program execution unit 10 discharges the paper on which the operating print processing unit 20b performs the print processing to the paper discharge tray 5a, and causes the operating print processing unit 20b to again print the image data P3 assigned at the time when the detection of being non-operating has been performed and the image data P4 to P8 subsequent to the image data P3. Incidentally, in the case where a print processing unit other than the print processing units 20a and 20b is provided in the MFP apparatus 1, the program execution unit 10 causes the other operating print processing unit to again print the image data P3 to P8.

As described above, one print job is processed as a plurality of jobs, and even in the case where the print output unit 20a becomes unable to print by a jam or the like while the plurality of image data are being print-processed in parallel in the plurality of print output units 20a and 20b, the MFP apparatus 1 of the embodiment uses the printable print output unit 20b and can continue the printing in the correct page order That is, the printing order does not become incorrect, and the recovery processing of the print is automatically realized.

As stated above, according to the invention, it becomes unnecessary to perform a processing to set the priority order for each job type. Besides, papers can be equally outputted at a rate per unit time desired by the user, the plurality of print execution units, such as the print output units 20a and 20b, can be efficiently used, and the flexible print output about which the user has few complaints becomes possible.

Besides, since the setting of the print priority of the MFP apparatus 1 of the embodiment and the determination of the print priority can be performed by a well-known method, a detailed description will not be made here.

In this way, according to the invention, the plurality of print output units 20a and 20b each having the same function are provided, the program execution unit 10 divides one job into a plurality of jobs, these divided jobs are assigned to the respective print output units 20a and 20b, and each of the plurality of print output units 20 executes and processes the assigned job, and therefore, even while a processing of a print job requiring much time is being performed, a copy job or a FAX job subsequent to the print job can be processed without being waited.

Besides, according to the invention, after a plurality of print jobs, for example, two jobs having the same priority occur, the set priority can be later changed such that one of the print jobs is first completed. For example, the priority is set between a print job of a tray having a specific function such as stapling and a print job of a normal paper discharge tray, and the print processing can be performed.

Besides, according to the invention, in the case where it is detected that one of the plurality print output units 20a and 20b can not perform the print processing because of, for example, cover opening, toner depletion or a jam, the program execution unit 10 removes the inoperable print output unit 20a, and can continue the printing by using only the operable print output unit 20b. At this rime, the original document, which has not been printed, is again printed by the operable printout put unit Besides, in the case where it is detected that the order of original documents is changed during the re-printing processing, the paper discharge tray to which the original document is to be sent is changed, or the paper discharge processing is shifted, and the incorrect order original document is removed.

Incidentally, the number of the print output units 20, the number of the paper feed trays 4 and the number of the paper discharge trays 5 can be variously changed. Although the recovery processing is the processing using the two print output units 20a and 20b as the print processing units, the MFP apparatus 1 of the embodiment can also perform the recovery processing using three or more print processing units. In the description, although the printed papers are sent to the paper discharge trays 5a to 5e, the MFP apparatus 1 of the embodiment can be structured such that a printed paper is transported to a desired paper discharge port, and the transported paper is taken out from the desired paper discharge port. Besides, image data to be printed can also be printed on a print object or a print medium different from paper.

Although exemplary embodiments of the present invention have been shown and described, it will be apparent to those hating ordinary skill in the art that a number of changes, modifications, or alterations to the invention as described herein may be made, none of which depart from the spirit of the present invention. All such changes, modifications, and alterations should therefore be seen as within the scope of the present invention

What is claimed is:

1. A multi function peripheral apparatus having a plurality of print processing units to print-process a plurality of data with printing order in turn, comprising a printing order registration unit configured to register, with respect to a plurality of print jobs including a plurality of image data, a printing order of each of the plurality of image data for each of the print jobs;
a priority setting unit configured to set a priority to each of the plurality of print jobs; and
an image data assigning unit configured to assign each of the plurality of image data included in the plurality of print jobs to a print processing unit of the plurality of print processing units based on the printing order registered in the printing order registration unit and the priority set in the priority setting unit

2. The multi function peripheral apparatus of claim 1, further comprising a sorting unit configured to sort papers printed in the plurality of print processing units to a tray of a plurality of trays.

3. The multi function peripheral apparatus of claim 1, further comprising a sensor to detect an operating state of a print processing unit of the plurality of print processing units.

4. The multi function peripheral apparatus of claim 3, wherein the image data assigning unit selects a print processing unit different from a non-operating print processing unit detected to be non-operating by the sensor, and assigns image data subsequent to image data, which is assigned at a time when the detection of being non-operating has been performed, among the plurality of image data included in the plurality of print jobs to the selected print processing unit.

5. The multi function peripheral apparatus of claim 3, wherein the image data assigning unit selects a print processing unit different from a non-operating print processing unit detected to be non-operating by the sensor, and assigns image data to be printed in the non-operating print processing unit among the plurality of image data included in the plurality of print jobs to the selected print processing unit.

6. The multi function peripheral apparatus of claim 4, wherein the image data assigning unit discharges papers on which the selected print processing unit performs a print processing to a tray of a plurality of trays, and causes either one of the operating print processing units to again print the image data, which is assigned at the time when the detection of being non-operating has been performed, among the plurality of image data and other image data subsequent to this image data.

7. The multi function peripheral apparatus of claim 5, wherein the image data assigning unit discharges papers on which the selected print processing unit performs a print processing to a tray of a plurality of trays, and causes either one of the operating print processing units to again print image data, which is assigned at a time when the detection of being non-operating has been performed, among the plurality of image data and other image data subsequent to this image data.

8. A multi function peripheral apparatus having a plurality of print processing means for print-processing a plurality of data with printing order in turn, comprising:
printing order registration means for registering, with respect to a plurality of print jobs including a plurality of image data, a printing order of each of the plurality of image data for each of the print jobs;
priority setting means for setting a priority to each of the plurality of print jobs; and
image data assigning means for assigning each of the plurality of image data included in the plurality of print jobs to either one of the plurality of print processing means based on the printing order registered in the printing order registration means and the priority set in the priority setting means.

9. The multi function peripheral apparatus of claim 8, further comprising sorting means for sorting papers printed in the plurality of print processing means to a tray of a plurality of trays.

10. The multi function peripheral apparatus of claim 8, further comprising detection means for detecting an operating state of either one of the plurality of print processing means.

11. The multi function peripheral apparatus of claim 10, wherein the image data assigning means selects print processing means different from non-operating print processing means detected to be non-operating by the detection means, and assigns image data subsequent to image data, which is assigned at a time when the detection of being non-operating has been performed, among the plurality of image data included in the plurality of print jobs to the selected print processing means.

12. The multi function peripheral apparatus of claim 10, wherein the image data assigning means selects print processing means different from non-operating print processing means detected to be non-operating by the detection means, and assigns image data to be printed in the non-operating print processing means among the plurality of image data included in the plurality of print jobs to the selected print processing means.

13. The multi function peripheral apparatus of claim 11, wherein the image data assigning means discharges papers on which the selected print processing means performs a print processing to a tray of a plurality of trays, and causes either one of the operating print processing means to again print the image data, which is assigned at the time when the detection of being non-operating has been performed, among the plurality of image data and other image data subsequent to this image data.

14. The multi function peripheral apparatus of claim 12, wherein the image data assigning means discharges papers on which the selected print processing means performs a print processing to a tray of a plurality of trays, and causes either one of the operating print processing means to again print image data, which is assigned at a time when the detection of being non-operating has been performed, among the plurality of image data and other image data subsequent to this image data.

15. A printing method for a multi function peripheral apparatus having a plurality of print processing units to print-process a plurality of data with printing order in turn, comprising the steps of:
registering, with respect to a plurality of print jobs including a plurality of image data, a printing order of each of the plurality of image data for each of the print jobs by a printing order registration unit configured to register the printing order of each of the plurality of image data for each of the print jobs;
setting a priority to each of the plurality of print jobs by a priority setting unit configured to set a priority to data to be printed;
assigning each of the plurality of image data included in the plurality of print jobs to a print processing unit of the plurality of print processing units based on the printing order and the priority by an image data assigning unit configured to assign image data to the print processing unit based on the printing order registered in the printing order registration Unit and the priority set in the priority setting unit; and
printing each of the plurality of image data included in the plurality of print jobs by the print processing unit assigned by the image data assigning unit.

16. The printing method of claim 15, wherein a sorting unit provided to sort printed papers to a tray of a plurality of trays sorts papers printed in the plurality of print processing units to a tray of the plurality of trays.

17. The printing method of claim 15, wherein
a sensor provided to detect an operating state of either one of the print processing units detects an operating state of a print processing unit of the plurality of print processing units,
the image data assigning unit selects a print processing unit different from a non-operating print processing unit detected to be non-operating by the sensor, and
the selected print processing unit prints image data to be printed in the non-operating print processing unit among the plurality of image data included in the plurality of print jobs.

18. The printing method of claim 17, wherein
at detection in the sensor, it is detected that the printing order of the plurality of image data included in the plurality of print jobs is different from the registered printing order, and
at the assigning in the image data assigning unit, the print processing unit assigned to the image data detected to be different in the printing order by the sensor among the plurality of image data included in the plurality of print jobs is changed to a print processing unit different from the print processing unit assigned among the plurality of print processing units.
